(19) United States
(12) Patent Application Publication
(10) Pub. No.: US 2009/0156077 A1
(43) Pub. Date: Jun. 18, 2009

(54) Non-woven web having isotropic mechanical properties and preparation method of the same

(75) Inventor: ChaeHwan Hong, Gyeonggi-do (KR)

Correspondence Address: Edwards Angell Palmer & Dodge LLP, P.O. Box 55874, Boston, MA, 02205, US

(73) Assignees: Hyundai Motor Company, Seoul (KR); Kia Motors Corporation, Seoul (KR)

(21) Appl. No.: 12/214,732

(22) Filed: Jun. 21, 2008

(30) Foreign Application Priority Data
Dec. 13, 2007 (KR) 10-2007-0130438

(51) Int. Cl. D04H 13/00; B29C 47/00

(52) U.S. Cl. 442/327; 264/211.18

(57) ABSTRACT

The present invention relates to a non-woven web useful for the manufacture of suede-like fabric for a car seat cover and a preparation method thereof. The non-woven web according to the present invention is prepared from a copolymer of polyethylene terephthalate and polytrimethylene terephthalate by dispersion in water using a surfactant and crosslinking using flowing water, and has superior mechanical properties including touch, dyeability, wear resistance, etc. Particularly, with superior isotropic mechanical properties over existing materials, it is suitable to be used as car seat cover material.

### CROSS-REFERENCE TO RELATED APPLICATION

This patent application claims under 35 U.S.C. §119(a) the benefit of Korean Patent Application No. 10-2007-0130438 filed Dec. 13, 2007, the entire contents of which are incorporated herein by reference.

### BACKGROUND

(a) Technical Field

The present invention relates to a non-woven web useful for the manufacture of suede-like fabric for a car seat cover and a preparation method thereof.

(b) Background Art

With the recent trends in well-being, in-vehicle comfort becomes more important. It is because people spend more time in a car than before, and they want to protect themselves from various environmental pollutions. For the reasons, public interest on sheet materials for car seats is increasing.

Natural leather, artificial leather and fabric are used as sheet materials for car seats. In mid- to low-price cars, sheets made of fabric are used more frequently than natural leather.

Conventional fabrics for car seats are mostly prepared from fibers based on polyethylene terephthalate (PET). With good crystallinity, PET is advantageous in fiber strength, but it is unfavorable in touch and dyeability. In order to solve this problem, there have been attempts to modify the fiber configuration, for example, by changing the yarn thickness. But, the result is unsatisfactory.

Recently, use of suede-like materials mimicking natural leather is increasing in car seats. Suede-like fabric is prepared from the process of spinning, preparing single fibers, forming web through interlocking of the single fibers, and polyurethane impregnation, raising and dyeing.

Conventionally, artificial fiber for such suede-like material has been prepared from polyethylene terephthalate polymer or a blend thereof with other polymers. But, because of differences in physical properties along the length and width directions, uneven shrinkage and deformation may occur under harsh conditions such as long riding. Accordingly, there has been a need for the development of an artificial fiber for suede-like materials having isotropic physical properties.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The inventors of the present invention have made various efforts to solve the aforesaid problems. As a result, they have found that a non-woven web prepared using a copolymer of PET and polytrimethylene terephthalate (PTT) as base resin has improved isotropic physical properties, touch and dyeability, since the anisotropic crystallinity and stiffness of the polyethylene terephthalate are compensated for by the elasticity provided by the PTT.

Accordingly, an object of the present invention is to provide a non-woven web having improved isotropic physical properties, touch and dyeability.

Another object of the present invention is to provide a preparation method of the non-woven web.

To attain the aforesaid objects, in one aspect, the present invention provides a non-woven web prepared by dispersing in water single fibers prepared from a copolymer of PET and PTT and crosslinking the same using flowing water.

In a preferred embodiment of the present invention, the copolymer comprises 30 to 45 weight % of PTT based on the total weight of the copolymer.

In another aspect, the present invention provides a preparation method of a non-woven web comprising the steps of: condensation polymerizing terephthalic acid, ethylene glycol and 1,3-propanediol to obtain a copolymer; spinning the copolymer to form monofilaments and cutting the same to obtain single fibers; adding the single fibers along with a surfactant in a bath filled with water and dispersing the same in water by stirring; discharging water from the resultant dispersion and adding a polyurethane binder; and subjecting the resultant mixture of single fibers and polyurethane binder to flowing water to crosslink the single fibers.

In a preferred embodiment of the present invention, the thickness of the monofilaments is from 0.1 to 1.0 denier.

In another preferred embodiment of the present invention, the length of the single fibers is from 1 to 15 mm.

In yet another preferred embodiment of the present invention, the surfactant is at least one selected from the group consisting of C₁₄-C₂₀ higher alcohol polyoxyethylene ether, C₁₃-C₁₈ alkylphenol polyoxyethylene ether, C₁₅-C₂₀ fatty acid amine ethoxylate and C₁₃-C₁₇ ethoxylated alkanoamide.

In still yet another preferred embodiment of the present invention, the dispersion comprises 0.1 to 1.0 g of single fibers per liter (L) of water.

In a further preferred embodiment of the present invention, the polyurethane binder is added in an amount of 20 to 50 weight % based on the total weight of the mixture.

In a still further preferred embodiment of the present invention, the polyurethane binder is a condensation copolymer of methylene isocyanate and propyldiethanolamine.

The non-woven web according to the present invention has superior mechanical properties including touch, dyeability, wear resistance, etc. suitable to be used as car seat cover material.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

The above and other features and advantages of the present invention will be apparent from or are set forth in more detail in the accompanying drawings, which are incorporated in and form a part of this specification, and the following Detailed Description, which together serve to explain by way of example of the principles of the present invention.

### BRIEF DESCRIPTION OF THE DRAWINGS

The above and other features of the present invention will now be described in detail with reference to certain exemplary embodiments thereof illustrated by the accompanying drawings which are given hereinbelow by way of illustration only, and thus are not limitative of the present invention, and wherein:

FIG. 1 shows the molecular structures of PET and PTT;

FIG. 2 illustrates the process of copolymerization of PET and PTT; and

FIG. 3 schematically illustrates a water flow providing apparatus that can be used in the present invention, wherein (a) and (c) are water jet spraying means and (b) represents interlocked single fibers.

### DETAILED DESCRIPTION

Reference will now be made in detail to the preferred embodiments of the present invention, examples of which are illustrated in the drawings attached hereinafter.

The present invention provides a non-woven web prepared by dispersing in water single fibers prepared from a copolymer of PET and PTT and crosslinking the single fibers using flowing water.

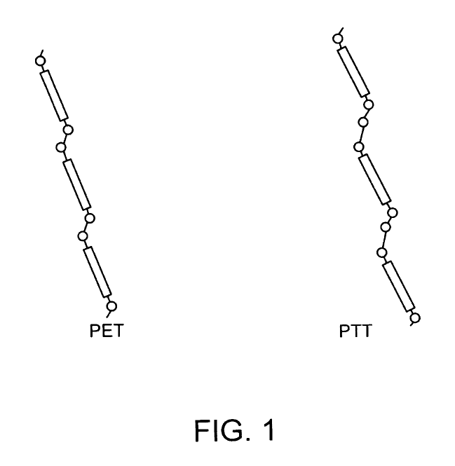

PTT has a molecular structure similar to that of PET, but exhibits different properties because of difference in the number of methylene groups, and compensates for the drawbacks of PET. PET has dense crystalline structure provided by repeated methylene units in the molecule, which, while providing good strength, shows poor touch and dyeability and exhibits anisotropic tensile characteristics. That is, it has different tensile characteristics in the transverse and longitudinal directions. For this reason, products made of PET tend to shrink and fold anisotropically upon long-term use (see FIG. 1).

To solve this problem associated with the use of PET homopolymer, the present invention proposes the use of a copolymer of PET and PTT.

PTT is prepared by condensation polymerization of terephthalic acid (PTA) and 1,3-propanediol (1,3-PDO). The three repeating methylene units of 1,3-PDO reduce the crystallinity of the product. These methylene units result in a helical crystalline structure. Accordingly, PTT is highly elastic, and provides improved touch when raising is performed after the manufacture of fabrics.

Consequently, in the copolymer, the anisotropic physical properties of PET are compensated for by PTT.

In the copolymer according to the present invention, PTT is preferably comprised in an amount that can provide the compensation effect while maintaining other properties of PET. That is, PTT is preferably comprised in the copolymer in an amount from 30 to 45 weight %. When the content is below 30 weight %, the isotropic properties of the resultant non-woven web fabric may be deteriorated because of strong crystalline characteristics of PET. On the other hand, when the content exceeds 45 weight %, strength, wear resistance, etc., may be deteriorated.

In another aspect, the present invention further provides a preparation method of a non-woven web. The method comprises: condensation polymerizing terephthalic acid, ethylene glycol and 1,3-propanediol to obtain a copolymer; spinning the copolymer to form monofilaments and cutting the same to obtain single fibers; adding the single fibers along with a surfactant in a bath filled with water and dispersing the same in water by stirring; discharging water from the resultant dispersion and adding a polyurethane binder; and subjecting the resultant mixture of single fibers and polyurethane binder to flowing water to crosslink the single fibers.

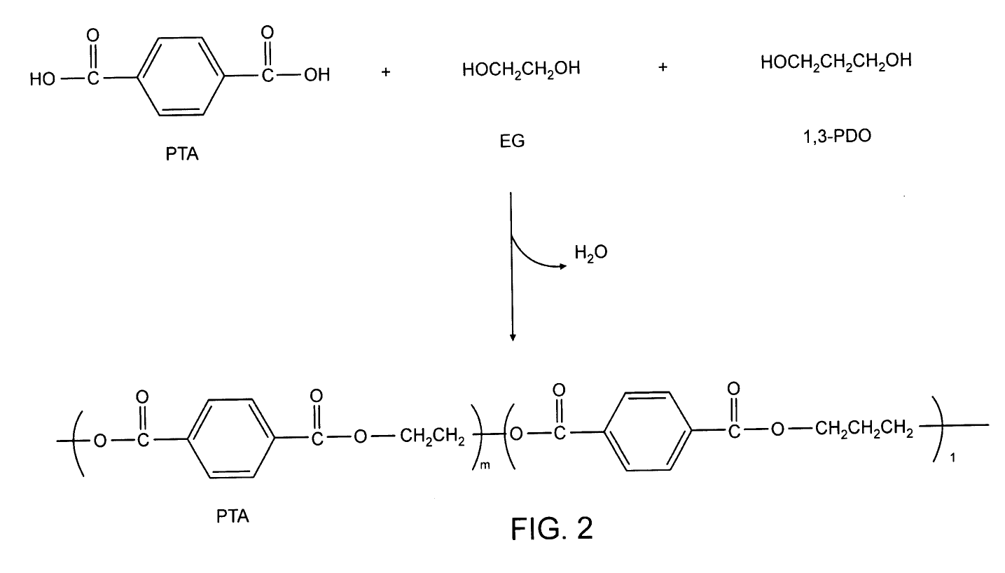

In the condensation polymerization of terephthalic acid, ethylene glycol and 1,3-propanediol, terephthalic acid and ethylene glycol are condensed to give PET, and terephthalic acid and 1,3-propanediol are condensed to give PTT (see FIG. 2). The proportions of the reactants terephthalic acid, ethylene glycol and 1,3-propanediol are determined so that the PTT content of the resultant copolymer is from 30 to 45 weight %. Preferably, for example, 20 to 40 weight % of terephthalic acid, 30 to 50 weight % of ethylene glycol and 20 to 40 weight % of 1,3-propanediol may be used.

Further, the condensation polymerization may be performed under any known condition in the related art, but the present invention is not limited thereto.

Subsequently, the thus prepared copolymer of PET and PTT is spun to form monofilaments, which are cut to obtain single fibers.

The spinning of the copolymer to form monofilaments may be performed by any known method in the related art. Preferably, for example, melt spinning may be used.

Preferably, the monofilaments prepared by the spinning have a thickness from 0.1 to 1.0 denier, more preferably from 0.25 to 0.5 denier. When the thickness is smaller than 0.1 denier, mechanical properties may be deteriorated upon formation of the non-woven web. Meanwhile, when the thickness is greater than 1.0 denier, isotropic properties of the resultant non-woven web may be deteriorated.

Also, preferably, the single fibers obtained by cutting the monofilaments have a length from 1 to 15 mm, more preferably from 5 to 10 mm. When the single fibers are shorter than 1 mm, it is not easy to crosslink the single fibers by flowing water, thereby resulting in decreased productivity. By contrast, when they are longer than 15 mm, the single fibers may form clusters during crosslinking, thereby resulting in non-uniform dispersion and leading to anisotropic mechanical properties of the resultant non-woven web.

Subsequently, the prepared single fibers are added along with a surfactant in a bath filled with water and stirred to disperse the single fibers in water.

The surfactant is added to promote the dispersion of the single fibers in water. Preferably, a non-ionic surfactant is used. A non-ionic surfactant is dissolved in aqueous solution without being ionized. It has several polar groups in the molecule. Typically, it consists of a polar head comprising oxyethylene (—CH₂CH₂O—) or oxypropylene (—CH₂CH(CH₃)O—) repeating units and a non-polar tail. Preferred examples of the non-ionic surfactant include C₁₄-C₂₀ higher alcohol polyoxyethylene ether, C₁₃-C₁₈ alkylphenol polyoxyethylene ether, C₁₅-C₂₀ fatty acid amine ethoxylate and C₁₃-C₁₇ ethoxylated alkanoamide. In the present invention, at least one selected from the above-listed surfactants may be used. For example, C₁₃-C₁₈ alkylphenol polyoxyethylene ether, alone or in combination with the other surfactant or surfactants may be used.

The amount of the single fibers to be added is preferably from 0.1 g/L to 1.0 g/L, more preferably from 0.2 g/L to 0.7 g/L, based on the volume of water. When the amount is less than 0.1 g/L, the industrial productivity will be deteriorated because of wasted water. In contrast, when the amount exceeds 1.0 g/L, the single fibers may not be dispersed uniformly, thus resulting in cluster formation and leading to anisotropic mechanical properties of the resultant non-woven web. Preferably, the stirring is performed sufficiently, so that the single fibers can be sufficiently dispersed in water. The present invention is not limited to specific conditions, including stirring speed or the like.

Subsequently, water is discharged from the resultant dispersion and a polyurethane binder is added. The polyurethane binder is added to prevent the single fibers from being blown away by the water flow during the crosslinking. Any known polyurethane binder in the related art may be used. Preferably, for example, a polyurethane obtained from the reaction of methylene isocyanate and propyldiethanolamine may be used.

Preferably, the polyurethane binder is added in an amount from 20 to 50 weight %, more preferably from 30 to 40 weight %, based on the total weight of the mixture. When single fibers are added less than 20 weight %, single fibers may be blown away by the strong water flow during the crosslinking. In contrast, when the single fibers are added more than 50 weight %, isotropic properties of the resultant web may be deteriorated.

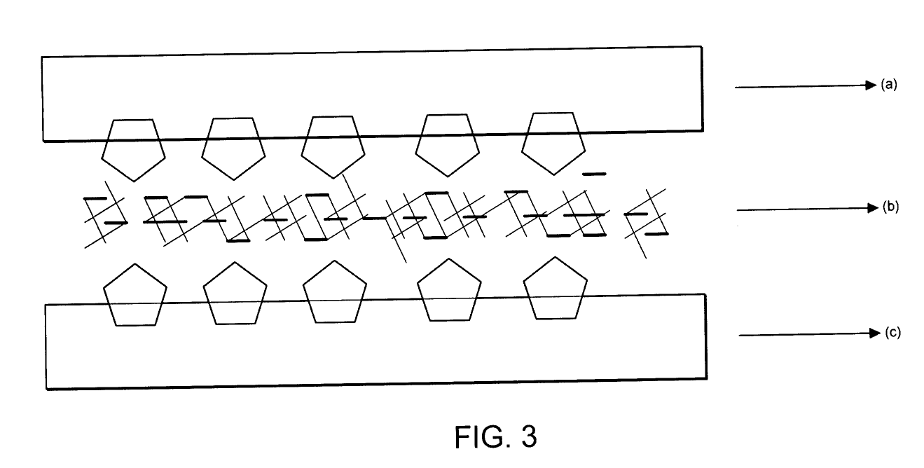

Subsequently, the resultant mixture of single fibers and polyurethane binder is subjected to strong water flow to crosslink the single fibers. The crosslinking may be performed by providing strong water flow to the interlocked single fibers using a water flow providing apparatus. For example, the water flow providing apparatus may be a water jet, but the present invention is not limited thereto (see FIG. 3).

Thus prepared non-woven web provides improved isotropic tensile strength, touch, dyeability, and so forth over conventional PET homopolymer or a blend of PET with other polymer(s).

### EXAMPLES

The following examples illustrate the present invention but they should not be construed as limiting the scope of the present invention.

### Examples 1 and 2

Copolymers of PET and PTT were prepared (see Table 1) and melt spun using an extruder maintained at 260° C. to obtain monofilaments of about 0.4 denier. The monofilaments were cut to a size of 5 to 10 mm to obtain single fibers, which were dispersed in water by adding the single fibers in water at a proportion of about 0.5 g/L, using polyoxyethylene nonylphenol ether (KONION NP-2, Greensoft Chem, Korea) as surfactant, and sufficiently stirring. After discharging water, a polyurethane binder prepared from the reaction of methylene isocyanate and propyldiethanolamine was added in an amount of 35 weight % based on the total weight of the mixture. The resultant mixture of single fibers and polyurethane binder was subjected to physical crosslinking using water flow. Strong water flow was provided downwardly and upwardly to the interlocked single fibers using a water jet. Isotropic tensile properties, touch, dyeability, color fastness and wear resistance of the thus prepared non-woven webs were evaluated as described below. The evaluation result is given in Table 2.

### Comparative Examples 1 and 2

Non-woven webs were prepared in the same manner as in Examples 1 and 2, except for using a PET homopolymer (Comparative Example 1) or a PTT homopolymer (Comparative Example 2). Evaluation of the non-woven webs was performed in the same manner as in Examples 1 and 2.

### Comparative Examples 3 and 4

Non-woven webs were prepared in the same manner as in Examples 1 and 2, except for preparing the non-woven webs by needle punching. Evaluation was performed in the same manner as in Examples 1 and 2. Needle punching is one of the methods used to make a non-woven web. Through repeated punching using various needles, single fibers are entangled mechanically to give a non-woven fabric with constant thickness and fiber density.

### Comparative Examples 5 and 6

Non-woven webs were prepared in the same manner as in Examples 1 and 2, except for using a blending composition of PET and PTT. Evaluation was performed in the same manner as in Examples 1 and 2.

TABLE 1

| | | | Comp. | Comp. | Comp. | Comp. | Comp. | Comp. Ex. |
|---|---|---|---|---|---|---|---|---|
| | Ex. 1 | Ex. 2 | Ex. 1 | Ex. 2 | Ex. 3 | Ex. 4 | Ex. 5 | 6 |
| PET (wt %) | 60 | 55 | 100 | 0 | 60 | 55 | 60 | 55 |
| PTT (wt %) | 40 | 45 | 0 | 100 | 40 | 45 | 40 | 45 |
| Crosslinking | ♯ | ♯ | ♯ | ♯ | ♯ | ♯ | ♯ | ♯ |
| using water | | | | | | | | |
| flow | | | | | | | | |
| Needle | X | X | X | X | ♯ | ♯ | X | X |
| punching | | | | | | | | |
| Surfactant | ♯ | ♯ | ♯ | ♯ | X | X | ♯ | ♯ |

### Evaluation

(1) Tensile Strength

In order to identify isotropy of the tensile properties of the non-woven web, tensile strength was measured according to ASTM D368 while varying the direction at 0°, 30°, 60°, 90°, 120° and 150°. When the tensile strength varies a lot at different directions, the non-woven web has poor isotropy.

(2) Touch

Touch of the fabric prepared by processing the non-woven web, including elongation and dyeing, was evaluated by five experts. The experts touched the fabric with hands and evaluated as good or bad. Evaluation standards are as follows: superior=evaluated as good by 4 or more experts; moderate=evaluated as good by 3 experts; poor=evaluated as good by 2 or less experts.

(3) Dyeability (Color Fastness)

Color fastness measurement was made according to the following Korean Industrial Standards (KS).

Fastness to washing: KS K 0430-A2

Fastness to abrasion: KS K 0650

Fastness to light: KS K 0218

(4) Wear Resistance

Sample was taken from the prepared non-woven web and rubbed against abrasion wheel CS-10 1,000 revolutions at a load of 500 g. A higher point means that abrasion occurred less.

TABLE 2

| | | | Comp. | Comp. | Comp. | Comp. | Comp. | Comp. |
|---|---|---|---|---|---|---|---|---|
| Category | Ex. 1 | Ex. 2 | Ex. 1 | Ex. 2 | Ex. 3 | Ex. 4 | Ex. 5 | Ex. 6 |
| Tensile | 0.2 ± 0.05 | 0.2 ± 0.05 | 0.2 ± 0.1 | 0.2 ± 0.15 | 0.2 ± 0.1 | 0.2 ± 0.15 | 0.2 ± 0.2 | 0.2 ± 0.2 |
| strength | | | | | | | | |
| (N/m²) | | | | | | | | |
| Touch¹⁾ | ♯ | ♯ | Δ | Δ | Δ | Δ | X | X |
| Fastness to | 4 | 4 | 4 | 3.5 | 4 | 3.5 | 3.5 | 3.5 |
| washing | | | | | | | | |
| (Level) | | | | | | | | |
| Fastness to | 4 | 4 | 4 | 4 | 4 | 4 | 3.5 | 3.5 |
| abrasion | | | | | | | | |
| (Level) | | | | | | | | |
| Fastness to | 4 | 4 | 3.5 | 3.5 | 3.5 | 3.5 | 3.5 | 3.5 |
| light (Level) | | | | | | | | |
| Wear | 5 | 5 | 5 | 5 | 5 | 5 | 5 | 2 |
| resistance | | | | | | | | |
| (Level) | | | | | | | | |

¹⁾♯: superior; Δ: moderate; X: poor

As shown in Table 2, the non-woven webs prepared according to the present invention (Examples 1 and 2) exhibited superior touch and dyeability and, particularly, significantly less variation of tensile strength at different directions, as compared with those of Comparative Examples 1 to 6.

A blending composition of PET and PTT is a physical mixture, in which the crystalline structures of PET and PTT are maintained. Accordingly, a non-woven web prepared from the blending composition exhibits anisotropic mechanical properties and is industrially less desirable. In contrast, a copolymer of polyethylene terephthalate and polytrimethylene terephthalate has polyethylene terephthalate and polytrimethylene terephthalate moieties in the same polymer. Accordingly, the properties thereof are compensated for and the resultant non-woven web has isotropic mechanical properties.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A non-woven web prepared by dispersing in water single fibers prepared from a copolymer of polyethylene terephthalate (PET) and polytrimethylene terephthalate (PTT) in water and crosslinking the single fibers using water flow.

2. The non-woven web according to claim 1, wherein the copolymer comprises 30 to 45 weight % of polytrimethylene terephthalate based on the total weight of the copolymer.

3. A preparation method of a non-woven web comprising the steps of:
condensation polymerizing terephthalic acid, ethylene glycol and 1,3-propanediol to obtain a copolymer;
spinning the copolymer to form monofilaments and cutting the same to obtain single fibers;
adding the single fibers along with a surfactant in a bath filled with water and dispersing the same in water by stirring;
discharging water from the resultant dispersion and adding a polyurethane binder; and
subjecting the resultant mixture of single fibers and polyurethane binder to flowing water to crosslink the single fibers.

4. The preparation method of a non-woven web according to claim 3, wherein the thickness of the monofilaments is from 0.1 to 1.0 denier.

5. The preparation method of a non-woven web according to claim 3, wherein the length of the single fibers is from 1 to 15 mm.

6. The preparation method of a non-woven web according to claim 3, wherein the surfactant is C₁₄-C₂₀ higher alcohol polyoxyethylene ether, C₁₃-C₁₈ alkylphenol polyoxyethylene ether, C₁₅-C₂₀ fatty acid amine ethoxylate, C₁₃-C₁₇ ethoxylated alkanoamide or any combination thereof.

7. The preparation method of a non-woven web according to claim 3, wherein the dispersion comprises 0.1 g/L to 1.0 g/L of single fibers based on the volume of water.

8. The preparation method of a non-woven web according to claim 3, wherein the polyurethane binder is added in an amount of 20 to 50 weight % based on the total weight of the mixture.

9. The preparation method of a non-woven web according to claim 3, wherein the polyurethane binder is a condensation copolymer of methylene isocyanate and propyldiethanolamine.

10. The preparation method of a non-woven web according to claim 3, wherein the mixture of single fibers and polyurethane binder is subjected to water flow using a water jet.
